(19) United States
(12) Patent Application Publication
(10) Pub. No.: US 2020/0358154 A1
(43) Pub. Date: Nov. 12, 2020

(54) BATTERY PACKAGING MATERIALS, METHODS OF MANUFACTURE, AND USES THEREOF

(71) Applicant: Rogers Corporation, Chandler, AZ (US)

(72) Inventors: Wei Wang, Waltham, MA (US); Ming Wei, Cranston, RI (US); David William Baker, Woodstock, CT (US)

(21) Appl. No.: 16/866,842

(22) Filed: May 5, 2020

Related U.S. Application Data
(60) Provisional application No. 62/843,792, filed on May 6, 2019.

(51) Int. Cl. H01M 10/659; H01M 2/02

(52) U.S. Cl. CPC H01M 10/659; H01M 2/0277; H01M 2/0287

(57) ABSTRACT

A thermal management battery packaging material includes a phase-change layer including a phase-change composition, wherein the phase-change composition comprises a combination of a phase-change material and a polymer; and a battery packaging layer disposed on a side of the phase-change layer.

### CROSS-REFERENCE TO RELATED APPLICATION

This application claims priority to U.S. Provisional Application No. 62/843,792, filed May 6, 2019, incorporated herein by reference in its entirety.

### BACKGROUND

Disclosed herein is multilayer, multifunctional material useful in particularly battery packaging, and methods for making and using the multilayer, multifunctional material.

Packaging is an important technological aspect in designing optimum, reliable, and safe batteries for operation. Desirable features for battery packaging include mechanical stability and durability, sealing (e.g., a high permeation barrier against humidity for lithium-ion batteries), high packing efficiency, compatibility with the installation of safety devices (e.g., current interrupt devices, valves, and the like), and chemical inertness. It would be a further advantage if the packaging was low cost and easy to manufacture. Coin cells and cylindrical batteries are typically sealed within a metal or alloy casing, e.g., stainless steel, nickel-plated steel, or an aluminum alloy. The casing of cylindrical cells can be wrapped with a polymer-based material, such as a heat shrink polymer. Prismatic cells are typically sealed within a casing that can be a metal or alloy (e.g., nickel-plated steel, steel, or an aluminum alloy) or a polymer-based material (e.g., polypropylene), and may have an exterior polymer-based wrap. Pouch cells are sealed within a metal laminate bag (“pouch”) with an exterior polymer layer; the metal is generally aluminum or aluminum alloy but can be other metals such as copper, stainless steel, or gold.

Despite the wide variety of polymer-based materials available for use in battery packaging (e.g., wraps, sleeves, or pouches), there remains a need in the art for materials having at least one improved property, and preferably an improved combination of properties.

### BRIEF SUMMARY

Disclosed herein is a thermal management battery packaging material and methods of making the thermal management battery packaging material.

A thermal management battery packaging material comprises a phase-change layer comprising a phase-change composition, wherein the phase-change composition comprises a combination of a phase-change material and a polymer; and a battery packaging layer disposed on a side of the phase-change layer.

A method of manufacturing the thermal management battery packaging material comprises contacting the phase-change layer and the battery packaging layer.

An article comprising a battery or a battery component and the thermal management battery packaging material is also disclosed.

The above described and other features are exemplified by the following figures, detailed description, and claims.

### BRIEF DESCRIPTION OF THE DRAWINGS

The following Figures are exemplary embodiments, which are provided to illustrate the present disclosure. The Figures are illustrative, and are not intended to limit articles or devices made in accordance with the disclosure of the materials, conditions, or process parameters set forth herein.

FIG. 1 is a schematic diagram showing an exemplary thermal management battery packaging material;

FIG. 2 is a schematic illustration of an exemplary thermal management battery packaging material; and

FIG. 3 is a graph showing voltage or temperature as a function of capacity (mAh) in discharge testing of a control cylindrical battery packaged with a prior art material and a cylindrical battery packaged with the thermal management battery packaging material of Example 1.

### DETAILED DESCRIPTION

As described above, a variety of battery packaging materials are known in the art. However, such materials are not designed to also have thermal management properties, that is, to provide heating and cooling of the battery. Overheating in a battery can result in increased internal cell resistance, can lower the battery cycle life, and potentially can present a safety issue, e.g., thermal runaway. Effective thermal management would be especially useful during fast charging and discharging of the battery.

The term “battery” refers to one or more electrochemical cells that are electrically connected to provide the required operating voltage and current. A “battery cell” refers to a single electrochemical cell.

Disclosed herein is a multilayer, multifunctional thermal management battery packaging material. The thermal management battery packaging material is easily manufactured and can be readily used as a packaging material for an individual battery cell or a battery comprising multiple cells. Advantageously, the thermal management battery packaging material can combine the desirable properties of a battery packaging material (mechanical stability and durability, sealing, high packing efficiency, compatibility with the installation of safety devices, and chemical inertness) with thermal management capabilities. The multilayer, multifunctional thermal management battery packaging material is easily processable, possesses good heat insulation properties, and has superior heat absorption properties to minimize cell heating.

The thermal management battery packaging material comprises a phase-change layer comprising a phase-change composition and a battery packaging layer disposed on a side of the phase-change layer. The phase-change composition includes a combination of a polymer and a phase-change material, preferably the phase-change material is evenly dispersed in the polymer. Optionally, the phase-change composition further comprises an additive composition. The phase-change material and the polymer are each selected to provide the phase-change composition with a good combination of mechanical properties and a high heat of fusion at a selected phase transition temperature.

The battery packaging layer comprises a polymer, a metal, or an alloy selected to provide suitable packaging for a desired cell or battery. Examples of suitable metals and alloys for the battery packaging layer include stainless steel, nickel-plated steel, aluminum, copper, nickel, gold foil, or an alloy thereof, such as nickel-copper, chromium-nickel steels, aluminum-iron, and nickel-chromium-iron alloys. Examples of suitable polymeric materials for the battery packaging layer include polyvinyl chloride, polystyrene, polyether sulfone, acrylonitrile-butadiene-styrene (ABS), styrene-acrylonitrile (SAN), polyesters such as polyethylene naphthalate (PEN) and polyethylene terephthalate (PET), polyvinylidene fluoride (PVDF), certain silicone rubbers, polyamides such as PA6, perfluoromethylvinylether, polyolefins such as polypropylene, polyethylene, or copolymers of polyethylene or polypropylene, and fluorinated polyolefins such as polytetrafluoroethylene and fluorinated ethylene-propylene (FEP), vinylidene fluoride, tetrafluoroethylene-vinylidene fluoride-hexafluoropropylene (HFP), and a combination thereof. In certain embodiments, the battery packaging layer comprises a heat shrink polymer. Exemplary heat-shrink polymers include polyvinylchloride, polyvinylidene fluoride, certain silicone rubbers, polyolefins, and fluorinated polyolefins such as polytetrafluoroethylene and fluorinated ethylene-propylene (FEP).

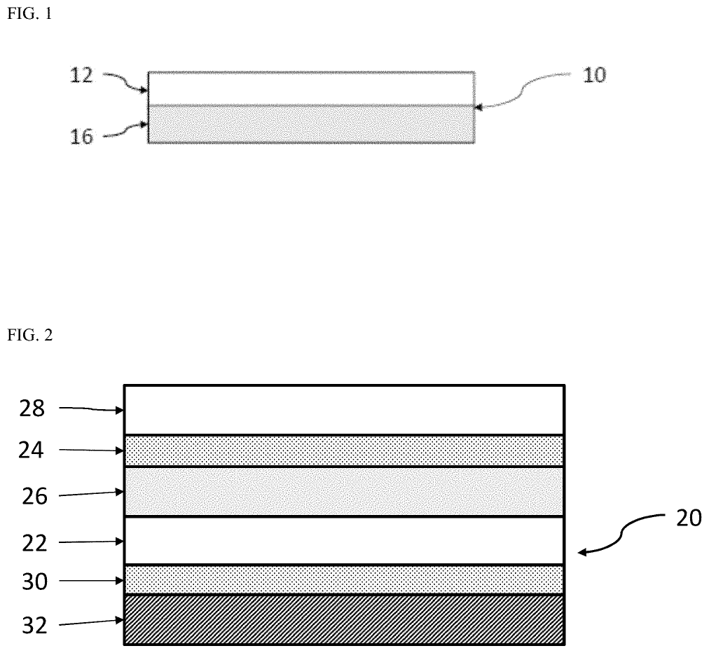

FIG. 1 is a schematic diagram showing an exemplary thermal management battery packaging material (10). As shown in FIG. 1, a battery packaging layer (12) is disposed on the phase-change layer (16). Another layer, e.g., a heat-conducting layer (not shown in FIG. 1), can optionally be present on a side of the phase-change layer (16), for example opposite the battery packaging layer. It is to be understood that “layer” as used herein includes various three-dimensional configurations suitable for use in a battery, for example to conform to a battery cell or module configuration. The layers can thus be of any suitable thickness, or can vary in thickness. Specific embodiments and forms of the layers are described in more detail below. “Disposed on” as used herein means that the layers can be directly contacting, or that intervening layers can be present, for example an adhesive layer or other intervening layer as described in further detail below.

The phase-change material (PCM) is a substance with a high heat of fusion and that is capable of absorbing and releasing high amounts of latent heat during a phase transition, such as melting and solidification, respectively. During the phase change, the temperature of the phase-change material remains nearly constant. The phase-change material inhibits or stops the flow of thermal energy through the material during the time the phase-change material is absorbing or releasing heat, typically during the material's change of phase. In some instances, a phase-change material can inhibit heat transfer during a period of time when the phase-change material is absorbing or releasing heat, typically as the phase-change material undergoes a transition between two states. This action is typically transient and will occur until a latent heat of the phase-change material is absorbed or released during a heating or cooling process. Heat can be stored or removed from a phase-change material, and the phase-change material typically can be effectively recharged by a source of heat or cold.

Phase-change materials thus have a characteristic transition temperature. The term “transition temperature,” or “phase-change temperature” refers to an approximate temperature at which a material undergoes a transition between two states. In some embodiments, e.g. for a commercial paraffin wax of mixed composition, the transition temperature can be a temperature range over which the phase transition occurs. In principle, it is possible to use phase-change materials having a transition temperature of −100 to 150° C. in the phase-change compositions, or the phase-change material can have a transition temperature of −5 to 150° C., or 0 to 90° C., or 30 to 70° C., or 35 to 50° C. The selection of a phase-change material can depend on the transition temperature desired for a particular application. For use in light-emitting diodes and electronic component batteries, for example, the phase-change material can have a transition temperature of 0 to 115° C., 10 to 105° C., 20 to 100° C., or 30 to 95° C. In an embodiment, the phase-change material has a transition temperature of 25 to 105° C., or 28 to 60° C., or 45 to 85° C., or 60 to 80° C., or 80 to 100° C. A phase-change material having a transition temperature near normal body temperature or around 37° C. can be desirable for electronics applications to prevent user injury and protect overheating components. In other applications, for example a battery for an electric vehicle, a transition temperature of 65° C. or higher can be desirable. A phase-change material for such applications can have a transition temperature in the range of 45 to 85° C., or 60 to 80° C., or 80 to 100° C.

The transition temperature can be expanded or narrowed by modifying the purity of the phase-change material, their molecular structure, blending of phase-change materials, or any combinations thereof. By selecting two or more different phase-change materials and forming a combination, the temperature stabilizing range of the phase-change material can be adjusted for any desired application. A temperature stabilizing range can include a specific transition temperature or a range of transition temperatures. The resulting combination can exhibit two or more different transition temperatures or a single modified transition temperature when incorporated in the phase-change compositions described herein.

In some embodiments, it can be advantageous to have multiple or broad transition temperatures. If a single narrow transition temperature is used, this can cause thermal/energy buildup before the transition temperature is reached. Once the transition temperature is reached, then energy will be absorbed until the latent energy is consumed and the temperature will then continue to increase. Broad or multiple transition temperatures allow for temperature regulation and thermal absorption as soon as the temperature starts to increase, thereby alleviating any thermal/energy buildup. Multiple or broad transition temperatures can also more efficiently help conduct heat away from a component by overlapping or staggering thermal absorptions. For example, for a composition containing a first phase-change material (PCM1) that absorbs at 35 to 40° C. and a second phase-change material (PCM2) that absorbs at 38 to 45° C., PCM1 will start absorbing and controlling temperature until a majority of the latent heat is used, at which time PCM2 will start to absorb and conduct energy from PCM1 thereby rejuvenating PCM1 and allowing it to keep functioning.

The selection of the phase-change material can also depend upon the latent heat of the phase-change material. A latent heat of the phase-change material typically correlates with its ability to absorb and release energy/heat or modify the heat transfer properties of the article. In some instances, the phase-change material can have a latent heat of fusion that is at least 80 Joules/gram (J/g), or at least 100 J/g, or at least 120 J/g, or at least 140 J/g, or at least 150 J/g, or at least 170 J/g, or at least 180 J/g, or at least 185 J/g, or at least 190 J/g, or at least 200 J/g, or at least 220 J/g. Thus, for example, the phase-change material can have a latent heat of fusion of 20 J/g to 400 J/g, such as 80 J/g to 400 J/g, or 100 J/g to 400 J/g, or 150 J/g to 400 J/g, or 170 J/g to 400 J/g, or 190 J/g to 400 J/g.

The heat of fusion of the phase-change material, determined by differential scanning calorimetry according to ASTM D3418, can be greater than 150 Joules/gram, preferably greater than 180 Joules per gram, more preferably greater than 210 Joules/gram.

The phase-change material can be unencapsulated (“raw”) or encapsulated. Encapsulation of the phase-change material essentially creates a container for the phase-change material so that regardless of whether the phase-change material is in the solid or liquid state, the phase-change material is contained. Methods for encapsulating materials, such as phase-change materials, are known in the art (see for example, U.S. Pat. Nos. 5,911,923 and 6,703,127). Microencapsulated and macroencapsulated phase-change materials are also available commercially (e.g., from Microtek Laboratories, Inc.). Macrocapsules have an average particle size of 1000 to 10,000 micrometers, whereas microcapsules have an average particle size less than 1000 micrometers. The encapsulated phase-change material can be encapsulated in a microcapsule and the average particle size of the microcapsules can be 1 to 100 micrometers, or 2 to 50 micrometers, or 5 to 40 micrometers. Herein, average particle size is a volume weighted average particle size, determined for example using a Malvern Mastersizer 2000 Particle Analyzer, or equivalent instrumentation.

A wide variety of phase-change materials are known and can be used, and include various organic and inorganic substances. Examples of phase-change materials include hydrocarbons (e.g., straight-chain alkanes or paraffinic hydrocarbons, branched-chain alkanes, unsaturated hydrocarbons, halogenated hydrocarbons, and alicyclic hydrocarbons), silicone wax, fluorinated wax, alkanes, alkenes, alkynes, arenes, hydrated salts (e.g., calcium chloride hexahydrate, calcium bromide hexahydrate, magnesium nitrate hexahydrate, lithium nitrate trihydrate, potassium fluoride tetrahydrate, ammonium alum, magnesium chloride hexahydrate, sodium carbonate decahydrate, disodium phosphate dodecahydrate, sodium sulfate decahydrate, and sodium acetate trihydrate), waxes, oils, water, saturated and unsaturated fatty acids for example, caproic acid, caprylic acid, lauric acid, myristic acid, palmitic acid, stearic acid, arachidic acid, behenic acid, lignoceric acid cerotic acid, and the like), fatty acid esters (for example, fatty acid C₁₋₄ alkyl esters, such as methyl caprylate, methyl caprate, methyl laurate, methyl myristate, methyl palmitate, methyl stearate, methyl arachidate, methyl behenate, methyl lignocerate, and the like), fatty alcohols (for example, capryl alcohol, lauryl alcohol, myristyl alcohol, cetyl alcohol, stearyl alcohol, arachidyl alcohol, behenyl alcohol, lignoceryl alcohol, ceryl alcohol, montanyl alcohol, myricyl alcohol, and geddyl alcohol, and the like), dibasic acids, dibasic esters, 1-halides, primary alcohols, secondary alcohols, tertiary alcohols, aromatic compounds, clathrates, semi-clathrates, gas clathrates, anhydrides (e.g., stearic anhydride), ethylene carbonate, methyl esters, polyhydric alcohols (e.g., 2,2-dimethyl-1,3-propanediol, 2-hydroxymethyl-2-methyl-1,3-propanediol, ethylene glycol, polyethylene glycol, pentaerythritol, dipentaerythritol, pentaglycerine, tetramethylol ethane, neopentyl glycol, tetramethylol propane, 2-amino-2-methyl-1,3-propanediol, monoaminopentaerythritol, diaminopentaerythritol, and tris(hydroxymethyl)acetic acid), sugar alcohols (erythritol, D-mannitol, galactitol, xylitol, D-sorbitol), polymers (e.g., polyethylene, polyethylene glycol, polyethylene oxide, polypropylene, polypropylene glycol, polytetramethylene glycol, polypropylene malonate, polyneopentyl glycol sebacate, polypentane glutarate, polyvinyl myristate, polyvinyl stearate, polyvinyl laurate, polyhexadecyl methacrylate, polyoctadecyl methacrylate, polyesters produced by polycondensation of glycols (or their derivatives) with diacids (or their derivatives), and copolymers, such as polyacrylate or poly(meth)acrylate with alkyl hydrocarbon side chain or with polyethylene glycol side chain and copolymers including polyethylene, polyethylene glycol, polyethylene oxide, polypropylene, polypropylene glycol, or polytetramethylene glycol), metals, and combinations thereof. Various vegetable oils can be used, for example soybean oils, palm oils, or the like. Such oils can be purified or otherwise treated to render them suitable for use as phase-change materials. In an embodiment a phase-change material used in the phase-change composition is an organic substance.

Paraffinic phase-change materials can be a paraffinic hydrocarbon, that is, a hydrocarbon represented by the formula CₙHₙ₊₂, where n can range from 10 to 44 carbon atoms. The melting point and heat of fusion of a homologous series of paraffin hydrocarbons is directly related to the number of carbon atoms. Similarly, the melting point of a fatty acid depends on the chain length.

In an embodiment, the phase-change material can comprise a paraffinic hydrocarbon, a fatty acid, or a fatty acid ester having 15 to 40 carbon atoms, 18 to 35 carbon atoms, or 18 to 28 carbon atoms. The phase-change material can be a single paraffinic hydrocarbon, fatty acid, or fatty acid ester, or a combination of hydrocarbons, fatty acids, and/or fatty acid esters. In a preferred embodiment the phase-change material has a transition temperature of 5 to 70° C., 25 to 65° C., 35 to 60° C., or 30 to 50° C.

The phase-change composition further comprises a polymer. As used herein, “polymer” includes oligomers, ionomers, dendrimers, homopolymers, and copolymers (such as graft copolymers, random copolymers, block copolymers (e.g., star block copolymers), random copolymers, and the like. The polymer can be a single polymer or a combination of polymers. The combination of polymers can be, for example, a blend of two or more polymers having different chemical compositions, different weight average molecular weights, or a combination thereof. Careful selection of the polymer or of the combination of polymers allows for tuning of the properties of the phase-change compositions.

A wide variety of polymers can be used depending on the phase-change material and other desired characteristics of the phase-change composition. The polymer can be thermoset or thermoplastic. Exemplary polymers that are commonly considered thermoset include alkyds, bismaleimide polymers, bismaleimide triazine polymers, cyanate ester polymers, benzocyclobutene polymers, benzoxazine polymers, diallyl phthalate polymers, epoxies, hydroxymethylfuran polymers, melamine-formaldehyde polymers, phenolics (including phenol-formaldehyde polymers such as novolacs and resoles), polydienes such as polybutadienes (including homopolymers and copolymers thereof, e.g. poly(butadiene-isoprene)), polyisocyanates, polyureas, polyurethanes, triallyl cyanurate polymers, triallyl isocyanurate polymers, certain silicones, and polymerizable prepolymers (e.g., prepolymers having ethylenic unsaturation, such as unsaturated polyesters, polyimides), or the like. The prepolymers can be polymerized, copolymerized, or crosslinked, e.g., with a reactive monomer such as styrene, alpha-methylstyrene, vinyltoluene, chlorostyrene, acrylic acid, (meth)acrylic acid, a (C₁₋₆ alkyl)acrylate, a (C₁₋₆ alkyl) methacrylate, acrylonitrile, vinyl acetate, allyl acetate, triallyl cyanurate, triallyl isocyanurate, or acrylamide. The molecular weight of the prepolymers can be 400 to 10,000 Daltons on average.

Exemplary polymers that are generally considered thermoplastic include cyclic olefin polymers (including polynorbornenes and copolymers containing norbornenyl units, for example copolymers of a cyclic polymer such as norbornene and an acyclic olefin such as ethylene or propylene), fluoropolymers (e.g., polyvinyl fluoride (PVF), polyvinylidene fluoride (PVDF), fluorinated ethylene-propylene (FEP), polytetrafluoroethylene (PTFE), poly(ethylene-tetrafluoroethylene (PETFE), perfluoroalkoxy (PFA)), polyacetals (e.g., polyoxyethylene and polyoxymethylene), poly(C₁₋₆ alkyl)acrylates, polyacrylamides (including unsubstituted and mono-N- and di-N-(C₁₋₈ alkyl)acrylamides), polyacrylonitriles, polyamides (e.g., aliphatic polyamides, polyphthalamides, and polyaramides), polyamideimides, polyanhydrides, polyarylene ethers (e.g., polyphenylene ethers), polyarylene ether ketones (e.g., polyether ether ketones (PEEK) and polyether ketone ketones (PEKK)), polyarylene ketones, polyarylene sulfides (e.g., polyphenylene sulfides (PPS)), polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetherimides (including copolymers such as polyetherimide-siloxane copolymers), polyimides (including copolymers such as polyimide-siloxane copolymers), poly(C₁₋₆ alkyl)methacrylates, polymethacrylamides (including unsubstituted and mono-N- and di-N-(C₁₋₈ alkyl)acrylamides), polyolefins (e.g., polyethylenes, polypropylenes, and their halogenated derivatives (such as polytetrafluoroethylenes), and their copolymers, for example ethylene-alpha-olefin copolymers), polyoxadiazoles, polyoxymethylenes, polyphthalides, polysilazanes, polysiloxanes (silicones), polystyrenes (including copolymers such as acrylonitrile-butadiene-styrene (ABS) and methyl methacrylate-butadiene-styrene (MBS)), polysulfides, polysulfonamides, polysulfonates, polysulfones such as polyether sulfone, polythioesters, polytriazines, polyureas, thermoplastic polyurethanes (TPU), vinyl polymers (including polyvinyl alcohols, polyvinyl esters, polyvinyl ethers, polyvinyl halides (e.g, polyvinyl fluoride, polyvinyl chloride), polyvinyl ketones, polyvinyl nitriles, polyvinyl thioethers, and polyvinylidene fluorides), or the like. A combination including at least one of the foregoing polymers can be used.

A preferred type of polymer class is elastomers, which can be optionally crosslinked. In some embodiments, use of a crosslinked (i.e., cured) elastomer provides lower flow of the compositions at higher temperatures. Suitable elastomers can be elastomeric random, grafted, or block copolymers. Examples include natural rubber, butyl rubber, nitrile rubber, polydicyclopentadiene rubber, fluoroelastomers, ethylene-propylene rubber (EPR), ethylene-butene rubber, ethylene-propylene-diene monomer rubber (EPDM, or ethylene propylene diene terpolymer), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like.

Elastomeric block copolymers comprise a block (A) derived from an alkenyl aromatic compound and a block (B) derived from a conjugated diene. The arrangement of blocks (A) and (B) include linear and graft structures, including radial teleblock structures having branched chains. Examples of linear structures include diblock (A-B), triblock (A-B-A or B-A-B), tetrablock (A-B-A-B), and pentablock (A-B-A-B-A or B-A-B-A-B) structures as well as linear structures containing 6 or more blocks in total of A and B. Specific block copolymers include diblock, triblock, and tetrablock structures, and specifically the A-B diblock and A-B-A triblock structures. In some embodiments, the elastomer is a styrenic block copolymer (SBC) consisting of polystyrene blocks and rubber blocks. The rubber blocks can be polybutadiene, polyisoprene, their hydrogenated equivalents, or a combination thereof. Examples of styrenic block copolymers include styrene-butadiene block copolymers, e.g. Kraton D SBS polymers (Kraton Performance Polymers, Inc.); styrene-ethylene/propylene block copolymers, e.g., Kraton G SEPS (Kraton Performance Polymers, Inc.) or styrene-ethylene/butadiene block copolymers, e.g., Kraton G SEBS (Kraton Performance Polymers, Inc.); and styrene-isoprene block copolymers, e.g., Kraton D SIS polymers (Kraton Performance Polymers, Inc.). In an embodiment, the polymer is a styrene-ethylene/propylene block copolymer, e.g., Kraton G 1642. In other embodiments, the polymer is a styrene butadiene block copolymer, e.g. Kraton D1118.

In an embodiment, the polymer is Kraton G SEBS or SEPS, a styrene-butadiene block copolymer, polybutadiene, EPDM, natural rubber, butyl rubber, nitrile rubber, a thermoplastic polyurethane, cyclic olefin copolymer, polydicyclopentadiene rubber, or a combination thereof.

Preferably the polymer can comprise polyvinyl chloride, polystyrene, polyether sulfone, acrylonitrile-butadiene-styrene (ABS), styrene-acrylonitrile (SAN), polyester, polyethylene naphthalate (PEN), polyethylene terephthalate (PET), polyvinylidene fluoride (PVDF), perfluoromethylvinylether, polypropylene, polyethylene, copolymers of polyethylene or polypropylene, polytetrafluoroethylene, fluorinated ethylene-propylene (FEP), vinylidene fluoride, tetrafluoroethylene-vinylidene fluoride-hexafluoropropylene (HFP), a styrene-ethylene/propylene-styrene block copolymer, a styrene-butadiene block copolymer, a styrene-ethylene/butylene-styrene block copolymer, a polybutadiene, an isoprene, a polybutadiene-isoprene copolymer, an ethylene-propylene rubber, an ethylene-propylene-diene monomer rubber, a natural rubber, a nitrile rubber, butyl rubber, a cyclic olefin copolymer, polydicyclopentadiene rubber, a thermoplastic polyurethane, or a combination thereof.

The amount of the phase-change material in the phase-change composition depends on the type of material used, the desired transition temperature, the type of polymer used, and like considerations. The amount of the phase-change material can be 20 to 98 weight percent, or 40 to 97 weight percent, or 50 to 96 weight percent, or 50 to 95 weight percent, or 40 to 95 weight percent, or 50 to 90 weight percent, or 60 to 85 weight percent, or 75 to 85 weight percent, based on the total weight of the phase-change composition.

The phase-change material can comprise a combination of an encapsulated first phase-change material and an unencapsulated second phase-change material. The first and second phase-change materials can be the same or different. The phase-change material can comprise 50 weight percent to 100 weight percent of the encapsulated first phase-change material and 0 to 50 weight percent of the unencapsulated second phase-change material, based on the total weight of the phase-change combination; 80 weight percent to 100 weight percent of the encapsulated first phase-change material and 0 weight percent to 20 weight percent of the unencapsulated second phase-change material based on the total weight of the phase-change combination; or at least 90 weight % encapsulated first phase-change material and no more than 10 weight percent unencapsulated second phase-change material, based on the total weight of the phase-change combination; or at least 95 weight % encapsulated first phase-change material and no more than 5 weight percent unencapsulated second phase-change material, based on the total weight of the phase-change combination; or 100 weight % encapsulated phase-change material.

The polymer can be present in the phase-change composition in an amount of 2 to 40 weight percent, or 4 to 30 weight percent, or 5 to 20 weight percent, or 5 to 15 weight percent, or 2 to 80 weight percent, or 3 to 60 weight percent, or 4 to 20 weight percent, or 5 to 50 weight percent, or 10 to 50 weight percent, or 15 to 40 weight percent, or 15 to 25 weight percent, each based on the total weight of the phase-change composition.

In an embodiment, the phase-change material and the polymer are selected to have good compatibility, to permit a large amount of phase-change material to be present within the polymer matrix. The type and amount of the polymer can be selected to have good compatibility with the phase-change material, in order to efficiently retain a large quantity of the phase-change material, e.g., at least 40% by weight of the total phase-change composition, or at least 50% by weight of the total phase-change composition, or at least 75% by weight of the total composition, or at least 80% by weight of the total composition, or even 90 to 95% by weight of the total composition, within the polymer matrix. The capacity of the polymer to retain the phase-change material efficiently within the polymer matrix of the phase-change composition confers excellent heat management performance over long periods of time.

In certain embodiments, if a combination of two or more polymers is used, the polymers are preferably miscible, or are miscible when combined with the phase-change material. The polymer can also be selected to provide desired properties to the phase-change composition, e.g., a desired gelling temperature.

In certain embodiments, the polymer and unencapsulated phase-change material have good compatibility such that when mixed the polymer and unencapsulated phase-change material can form a miscible blend. One parameter that can be used to assess compatibility of the polymer with unencapsulated phase-change material is the “solubility parameter” (δ) of the polymer and of the unencapsulated phase-change material. Solubility parameters can be determined by any known method in the art or obtained for many polymers and phase-change materials from published tables. The polymer and phase-change material should have similar solubility parameters to form a miscible blend. The solubility parameter (δ) of the polymer is within ±1, or ±0.9, or ±0.8, or ±0.7, or ±0.6, or ±0.5, or ±0.4, or ±0.3 of the solubility parameter of the unencapsulated phase-change material.

The phase-change composition can have a transition temperature of 5 to 70° C., preferably 25 to 65° C., more preferably 35 to 60° C., yet more preferably 30 to 50° C.

For ease of manufacture and use, the phase-change composition does not exhibit appreciable flow at temperatures less than or equal to 100° C., or less than or equal to 80° C., or less than or equal to 50° C., or less than or equal to 30° C.

The phase-change composition can have a heat of fusion, determined by differential scanning calorimetry according to ASTM D3418, at the transition temperature of at least 120 Joules/gram, at least 150 Joules/gram, preferably at least 180 Joules/gram, more preferably at least 200 Joules/gram.

The phase-change compositions can consist of, or consist essentially of, the combination of the phase-change material and the polymer alone, in the amounts described above. Alternatively, the phase-change compositions can further comprise other components as additives, for example a filler, or other additives known in the art. Such additional components are selected so as to not significantly adversely affect the desired properties of the phase-change compositions. Individual additives can be present in amounts generally known in the art, for example 0.1 to 5 weight percent for additives such as antioxidants or curing agents. An additive composition in total can be present in the phase-change composition in an amount up to 60 weight percent (0.1 weight percent to 60 weight percent), or 0.1 to 40 weight percent, or 0.5 to 30 weight percent or 1 to 20 weight percent, with weight percent based on the total weight of the phase-change composition and wherein the weight percent of all components of the phase-change composition totals to 100 weight percent.

The phase-change composition can comprise a filler, for example a filler to adjust the dielectric, thermally conductive, or magnetic properties of the phase-change composition. A low coefficient of expansion filler, such as glass beads, silica or ground micro-glass fibers, can be used. A thermally stable fiber, such as an aromatic polyamide, or a polyacrylonitrile can be used. Representative dielectric fillers include titanium dioxide (rutile and anatase), barium titanate, strontium titanate, fused amorphous silica, corundum, wollastonite, aramide fibers (e.g., KEVLAR from DuPont), fiberglass, Ba₂Ti₉O₂₀, quartz, aluminum nitride, silicon carbide, beryllia, alumina, magnesia, mica, talcs, nanoclays, aluminosilicates (natural and synthetic), iron oxide, CoFe₂O₄ (nanostructured powder available from Nanostructured & Amorphous Materials, Inc.), single wall or multiwall carbon nanotubes, and fumed silicon dioxide, each of which can be used alone or in combination.

Other types of fillers that can be used include a thermoconductive filler, a thermally insulating filler, a magnetic filler, or a combination thereof. Thermoconductive fillers include, for example, boron nitride, silica, alumina, zinc oxide, magnesium oxide, and aluminum nitride. Examples of thermally insulating fillers include, for example, organic polymers in particulate form. The magnetic fillers can be nanosized.

The fillers can be in the form of solid, porous, or hollow particles. The particle size of the filler affects a number of important properties including coefficient of thermal expansion, modulus, elongation, and flame resistance. In an embodiment, the filler has an average particle size of 0.1 to 15 micrometers, specifically 0.2 to 10 micrometers. The filler can be a nanoparticle, i.e., a nanofiller, having an average particle size of 1 to 100 nanometers (nm), or 5 to 90 nm, or 10 to 80 nm, or 20 to 60 nm. A combination of fillers having a bimodal, trimodal, or higher average particle size distribution can be used. The filler can be included in an amount of 0.1 to 80 weight percent, specifically 1 to 65 weight percent, or 5 to 50 weight percent, based on a total weight of the phase-change composition.

In addition, the phase-change composition can further optionally comprise additives such as flame retardants, cure initiators, crosslinking agents, viscosity modifiers, wetting agents, antioxidants, thermal stabilizers, colorants, or a combination comprising at least one of the foregoing. The particular choice of additives depends on the polymer used, the particular application of the phase-change composition, and the desired properties for that application, and are selected so as to enhance or not substantially adversely affect the electrical properties of the circuit subassemblies, such as thermal conductivity, dielectric constant, dissipation factor, dielectric loss, or other desired properties.

The flame retardant can be a metal carbonate, a metal hydrate, a metal oxide, a halogenated organic compound, an organic phosphorus-containing compound, a nitrogen-containing compound, or a phosphinate salt. Representative flame-retardant additives include bromine-, phosphorus-, and metal oxide-containing flame retardants. Suitable bromine-containing flame retardants are generally aromatic and contain at least two bromines per compound.

Suitable phosphorus-containing flame retardants include various organic phosphorous compounds, for example an aromatic phosphate of the formula (GO)₃P═O, wherein each G is independently an C₁₋₃₆ alkyl, cycloalkyl, aryl, alkylaryl, or arylalkyl group, provided that at least one G is an aromatic group. Two of the G groups can be joined together to provide a cyclic group, for example, diphenyl pentaerythritol diphosphate. Other suitable aromatic phosphates can be, for example, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like. Examples of suitable di- or polyfunctional aromatic phosphorous-containing compounds include resorcinol tetraphenyl diphosphate (RDP), the bis (diphenyl) phosphate of hydroquinone, and the bis(diphenyl) phosphate of bisphenol-A, respectively, their oligomeric and polymeric counterparts, and the like.

Metal phosphinate salts can also be used. Examples of phosphinates are phosphinate salts such as for example alicyclic phosphinate salts and phosphinate esters. Further examples of phosphinates are diphosphinic acids, dimethylphosphinic acid, ethylmethylphosphinic acid, diethylphosphinic acid, and the salts of these acids, such as for example the aluminum salts and the zinc salts. Examples of phosphine oxides are isobutylbis(hydroxyalkyl) phosphine oxide and 1,4-diisobutylene-2,3,5,6-tetrahydroxy-1,4-diphosphine oxide or 1,4-diisobutylene-1,4-diphosphoryl-2,3,5,6-tetrahydroxycyclohexane. Further examples of phosphorous-containing compounds are NH1197® (Chemtura Corporation), NH1511® (Chemtura Corporation), NcendX P-30® (Albemarle), Hostaflam OP5500® (Clariant), Hostaflam OP910® (Clariant), EXOLIT 935 (Clariant), and Cyagard RF 1204®, Cyagard RF 1241® and Cyagard RF 1243R (Cyagard are products of Cytec Industries). In a particularly advantageous embodiment, a halogen-free composition has excellent flame retardance when used with EXOLIT 935 (an aluminum phosphinate). Still other flame retardants include melamine polyphosphate, melamine cyanurate, Melam, Melon, Melem, guanidines, phosphazanes, silazanes, DOPO (9,10-dihydro-9-oxa-10 phosphaphenanthrene-10-oxide), and 10-(2,5 dihydroxyphenyl)-10H-9-oxa-phosphaphenanthrene-10-oxide.

Suitable metal oxide flame retardants are magnesium hydroxide, aluminum hydroxide, zinc stannate, and boron oxide. Preferably, the flame retardant can be aluminum trihydroxide, magnesium hydroxide, antimony oxide, decabromodiphenyl oxide, decabromodiphenyl ethane, ethylene-bis (tetrabromophthalimide), melamine, zinc stannate, or boron oxide. A flame-retardant additive can be present in an amount known in the art for the particular type of additive used.

Exemplary cure initiators include those useful in initiating cure (cross-linking) of the polymers, in the composition. Examples include, but are not limited to, azides, peroxides, sulfur, and sulfur derivatives. Free radical initiators are especially desirable as cure initiators. Examples of free radical initiators include peroxides, hydroperoxides, and non-peroxide initiators such as 2,3-dimethyl-2,3-diphenyl butane. Examples of peroxide curing agents include dicumyl peroxide, alpha, alpha-di(t-butylperoxy)-m,p-diisopropylbenzene, 2,5-dimethyl-2,5-di(t-butylperoxy)hexane-3, and 2,5-dimethyl-2,5-di(t-butylperoxy)hexyne-3, or a combination thereof. The cure initiator, when used, can be present in an amount of 0.01 weight percent to 5 weight percent, based on the total weight of the phase-change composition.

Crosslinking agents are reactive monomers or polymers. In an embodiment, such reactive monomers or polymers are capable of co-reacting with the polymer in the phase-change composition. Examples of suitable reactive monomers include styrene, divinyl benzene, vinyl toluene, triallylcyanurate, diallylphthalate, and multifunctional acrylate monomers (such as Sartomer compounds available from Sartomer Co.), among others, all of which are commercially available. Useful amounts of crosslinking agents are 0.1 to 50 weight percent, based on the total weight of the phase-change composition.

Exemplary antioxidants include radical scavengers and metal deactivators. A non-limiting example of a free radical scavenger is poly[[6-(1,1,3,3-tetramethylbutyl)amino-s-triazine-2,4-diyl][(2,2,6,6,-tetramethyl-4-piperidyl)imino]hexamethylene[(2,2,6,6-tetramethyl-4-piperidyl)imino]], commercially available from Ciba Chemicals under the tradename CHIMASSORB 944. A non-limiting example of a metal deactivator is 2,2-oxalyldiamido bis[ethyl 3-(3,5-di-t-butyl-4-hydroxyphenyl)propionate] commercially available from Chemtura Corporation under the tradename NAUGARD XL-1. A single antioxidant or a combination of two or more antioxidants can be used. Antioxidants are typically present in amounts of up to 3 weight percent, specifically 0.5 to 2.0 weight percent, based on the total weight of the phase-change composition.

Coupling agents can be present to promote the formation of or participate in covalent bonds connecting a metal surface or filler surface with a polymer. Exemplary coupling agents include 3-mercaptopropylmethyldimethoxy silane and 3-mercaptopropyltrimethoxy silane and hexamethylenedisilazanes.

The phase-change composition can be manufactured by combining the polymer, the phase-change material, any additives, and optionally a solvent to manufacture the phase-change composition. The combining can be by any suitable method, such as blending, mixing, or stirring. In an embodiment, the phase-change material is molten and the polymer is dissolved in the molten phase-change material. In another embodiment, the components used to form the phase-change composition, including the polymer and the phase-change material and the optional additives, can be combined by being dissolved or suspended in a solvent to provide a mixture or solution.

The solvent, when included, is selected so as to dissolve the polymer, disperse the phase-change material and any other optional additives that can be present, and to have a convenient evaporation rate for forming and drying. A non-exclusive list of possible solvents is xylene; toluene; methyl ethyl ketone; methyl isobutyl ketone; hexane, and higher liquid linear alkanes, such as heptane, octane, nonane, and the like; cyclohexane; isophorone; various terpene-based solvents; and blended solvents. Specific exemplary solvents include xylene, toluene, methyl ethyl ketone, methyl isobutyl ketone, and hexane, and still more specifically xylene and toluene. The concentration of the components of the composition in the solution or dispersion is not critical and will depend on the solubility of the components, the filler level used, the method of application, and other factors. In general, the solution comprises 10 to 80 weight percent solids (all components other than the solvent), more specifically 50 to 75 weight percent solids, based on the total weight of the solution.

Any solvent is allowed to evaporate under ambient conditions, or by forced or heated air, and the combination is cooled to provide a gelled phase-change composition. The phase-change composition can also be shaped by known methods, for example extruding, molding, or casting. For example, the phase-change composition can be formed into a layer by casting onto a carrier from which it is later released, or alternatively onto the protective polymer layer, or co-extruded with the protective polymer layer as described below. The phase-change layer can be uncured or partially cured (B-staged) in the drying process, or the layer can be partially or fully cured, if desired, after drying. The layer can be heated, for example at 20 to 200° C., specifically 30 to 150° C., more specifically 40 to 100° C. The resulting phase-change composition can be stored prior to use, for example lamination and cure, partially cured and then stored, or laminated and fully cured.

The thermal management battery packaging material can further comprise a protective polymer layer. The protective polymer layer can be any polymer known for use in batteries, particularly as a packaging material in batteries. Exemplary materials include polyvinyl chloride, polystyrene, polyether sulfones, acrylonitrile-butadiene-styrene (ABS), styrene-acrylonitrile (SAN), polyesters such as polyethylene naphthalate (PEN) and polyethylene terephthalate (PET), polyvinylidene fluoride (PVDF), certain silicone rubbers, polyamides such as PA6, perfluoromethylvinylether, polyolefins such as polypropylene, polyethylene, or copolymers of polyethylene or polypropylene, and fluorinated polyolefins such as polytetrafluoroethylene and fluorinated ethylene-propylene (FEP), vinylidene fluoride, tetrafluoroethylene-vinylidene fluoride-hexafluoropropylene (HFP), or a combination thereof. Biaxially oriented polyesters or polyamides can be used. The protective polymer layer can include multiple layers, such as a biaxially oriented polyester film and a biaxially oriented polyamide film.

In an embodiment, the protective polymer layer comprises a heat shrink polymer. Use of heat shrink polymers allows the production of more conformal packaging. Exemplary heat shrink polymers include polyvinylchloride, polyvinylidene fluoride, certain silicone rubbers, polyolefins, and fluorinated polyolefins such as polytetrafluoroethylene and fluorinated ethylene-propylene (FEP).

In another embodiment, the protective polymer layer comprises a heat-conductive polymer, that is, a polymer rendered heat-conductive by the addition of a thermally-conductive filler as described above.

Other layers can be present in the thermal management battery packaging material, disposed on the phase-change layer, on the battery packaging layer, or between the phase-change layer and the battery packaging layer. An adhesive, a primer, or both can be used to improve adhesion between the various layers. Primers and adhesives for the various layers are known. Metal adhesion layers, for example, include graft-modified polyolefin resins with unsaturated carboxy groups, such as maleic acid, itaconic acid, and fumaric acid, maleic acid monoesters, maleic acid diesters, maleic acid anhydride, itaconic acid monoester, itaconic acid diesters, itaconic acid anhydride, fumaric acid monoester, fumaric acid diester include esters and anhydrides such as fumaric acid. The polyolefins can be polypropylene, ultralow density polyethylene, high density polyethylene, ethylene-vinyl acetate copolymers, ethylene-ethyl acrylate copolymers, and ethylene-methacrylate copolymers.

FIG. 2 schematically shows an exemplary pouch thermal management battery packaging material (20) having six layers. As shown in FIG. 2, thermal management battery packaging material (20) comprises metal battery packaging layer (22) disposed on phase-change layer (26), adhesive layer (24) is disposed between phase-change layer (26) and protective polymer layer (28), and adhesive layer (30) is disposed between metal battery packaging layer (22) and inner sealant layer (32).

In a specific embodiment, a metal barrier layer is present in the thermal management battery packaging material, for example a layer of aluminum, copper, nickel, stainless steel, gold, or an alloy thereof, such as nickel-copper, aluminum-iron, or nickel-chromium-iron alloys. A metal barrier layer can improve mechanical stability and thermal resistance of the battery material. Aluminum or aluminum alloy barrier layers are preferred, for reasons of cost, performance, and ease of manufacture.

Other layers that can be present include an inner sealant layer, as shown in FIG. 2. The inner sealant layer can be used to protect the other layers of the packaging material from the electrolyte or other corrosive materials used in batteries. Exemplary materials for use in this layer include the various polymers described above for use in the protective layer, including the heat shrink polymers. Olefin-based thermoplastic elastomers (TPO) can be used. In an embodiment, the inner sealant layer can be thermally conductive, for example by the incorporation of a thermally conductive filler as described above.

The thickness of each of the layers of the thermal management battery packaging material can vary depending on its intended use, including the type of battery, its configuration, and intended shipping and operation conditions.

The phase-change layer can have a thickness of at least 5 micrometers, at least 10 micrometers, at least 20 micrometers, at least 50 micrometers, or at least 100 micrometers and no more than 300 micrometers, no more than 500 micrometers, no more than 1 millimeter (mm), no more than 2 millimeters, or no more than 5 millimeters.

The battery packaging layer has a thickness suitable for the size and type of battery or cell to be packaged. For example, for a pouch cell, typical thicknesses of a battery packaging metal layer are in the range of 20 micrometers up to 100 micrometers. A thickness less than 20 micrometers can result in a reduced barrier property due to pinholes and a reduced mechanical stability of the foil during molding.

The protective polymer layer can have a thickness of at least 5 micrometers, at least 10 micrometers, at least 20 micrometers, at least 50 micrometers, or at least 100 micrometers and no more than 400 micrometers, no more than 500 micrometers, no more than 1 millimeter, or no more than 2 millimeter, or no more than 10 mm. For example, the protective polymer layer can be 5 micrometers to 10 millimeter, 10 micrometers to 2 millimeter, or 20 micrometers to 1 millimeter.

The metal barrier layer can have a thickness of at least 1 micrometer, at least 10 micrometers, at least 20 micrometers, at least 50 micrometers, or at least 100 micrometers and no more than 200 micrometers, no more than 250 micrometers, no more than 300 micrometers, no more than 400 micrometers, or no more than 500 micrometers.

The inner sealant layer can have a thickness of at least 5 micrometers, at least 10 micrometers, at least 20 micrometers, at least 50 micrometers, or at least 100 micrometers and no more than 400 micrometers, no more than 500 micrometers, no more than 1 millimeter, or no more than 2 millimeter. For example, the inner sealant layer can be 5 micrometers to 10 millimeter, 10 micrometers to 2 millimeter, or 20 micrometers to 1 millimeter.

The thermal management battery packaging material can be manufactured by contacting the phase-change layer and the battery packaging layer. The contacting of the phase-change layer and the battery packaging layer can be performed by any suitable method. Examples of suitable methods include coating the phase-change layer onto the battery packaging layer, coating the battery packaging layer onto the phase-change layer, laminating the phase-change layer and the battery packaging layer, co-extruding the phase-change layer and the battery packaging layer, or adhering the phase-change layer and the battery packaging layer with an adhesive. Each layer can be pre-formed and then contacted, or one or more layers can be formed during the contacting. For example, contacting can be by laminating a phase-change layer and the battery packaging layer with or without an intervening adhesive. Alternatively, the phase-change composition and the battery packaging layer can be coextruded to form the thermal management battery packaging material. The thermal management battery packaging material can be directly co-extruded onto the surface of an article, for example one or more battery cells, to be packaged in the thermal management battery packaging material or onto a laminate for enclosing a pouch cell.

The method of manufacturing the thermal management battery packaging material can further comprise contacting a surface of the phase-change layer with a heat-conductive material. The surface can be opposite the surface with the protective polymer layer. The heat-conductive material can be a metal. In an embodiment, a surface of the phase-change layer can be coated with at least a partial coating of a metal barrier layer, such as an aluminum barrier layer. The metal barrier layer can completely coat the surface of the phase-change layer. Coating a metal, such as aluminum, onto the phase-change layer can be performed by any suitable method, for example physical vapor deposition, sputtering, thermal evaporation, chemical vapor deposition, or a combination thereof. The phase-change layer can also be coated on or laminated, with or without an adhesive, to a pre-formed heat-conductive layer, e.g., an aluminum layer.

An article comprising the thermal management battery packaging material is disclosed. The article can comprise a battery and the thermal management battery packaging material. The article can comprise a battery component and the thermal management battery packaging material. For example, the battery component can be a battery cell packaged with the thermal management battery packaging material. The thermal management battery packaging material can be formed to be suitable for use in coin cells, prismatic cells, pouch cells, and cylindrical cells. The thermal management battery packaging material can be used in a variety of applications, including battery packaging and electronic devices. The thermal management battery packaging material can be used in a wide variety of electronic devices, and any other devices, that generate heat to the detriment of the performance of the batteries, processors, and other operating circuits (memory, video chips, telecom chips, and the like).

The thermal management battery packaging materials described herein are easily processable, and can provide superior heat absorption properties to minimize cell heating, particularly during fast charging and discharging of the battery, which can improve battery electrochemical performance, life and safety.

The following examples are provided to illustrate the present disclosure. The examples are merely illustrative and are not intended to limit devices made in accordance with the disclosure to the materials, conditions, or process parameters set forth therein.

### EXAMPLES

The transition temperature and enthalpy (ΔH) of the transition of a material can be determined by differential scanning calorimetry (DSC), e.g., using a Perkin Elmer DSC 4000, or equivalent, according to ASTM D3418.

### Example 1: Shrink Thermal Management Packaging Material

A shrink thermal management battery packaging material for packaging a battery cell was made. A schematic of the material is shown in FIG. 1. In this thermal management packaging material, the battery packaging layer (12) is a shrink polyvinyl chloride (PVC) film. The phase-change layer of heat absorbing material is a phase-change composition selected to provide the desired latent heat absorption (a heat of fusion of at least 150 kJ/kg) at the desired phase transition temperature (about 42° C.). In this Example, HEATSORB thermal management material (a multilayer film product comprising a phase-change layer, Rogers Corporation) was used to provide the phase-change layer in the thermal management battery packaging material. The battery packaging layer helps to encapsulate the heat absorbing phase-change material.

### Example 2: Pouch Cell Thermal Management Packaging Material

Lithium ion pouch cell packaging typically comprises an aluminum laminate material.

In this example, the exemplary pouch cell thermal management packaging material schematically shown in FIG. 2 was made. A phase-change composition film is attached to an aluminum laminate material. The addition of the phase-change composition film to the standard aluminum laminate packaging material helps to reduce temperature fluctuations during dynamic operation of the enclosed battery cell.

### Example 3. Discharge Testing of Thermal Performance of the Shrink Thermal Management Packaging Material

To examine the thermal performance of the shrink thermal management packaging material of Example 1, a sample battery packaged with the Example 1 laminate is constructed for testing.

The sample battery is constructed by removing the original wrapping film from a commercial cylindrical 18650 rechargeable Li ion battery (capacity 2500 mAh, maximum discharge current 20 A, nominal voltage 3.6 V), and then wrapping a layer of phase-change composition (37° C. phase-change temperature; 1.4 millimeter thick) around the exposed battery casing followed by wrapping with a PVC heat-shrink film. A heating gun is used to blow hot air to the surface of the heat shrink film at a temperature below 60° C. while slowly rotating the battery until the heat-shrink film shrinks onto the battery cell.

An unmodified commercial 18650 rechargeable Li ion battery is selected as a control sample.

Discharge testing was performed at 25° C. in an environmental chamber with the test parameters below:

Current: 8 C (20 A)

Charge cut-off. 4.2V

Discharge cut-off: 2.5 V.

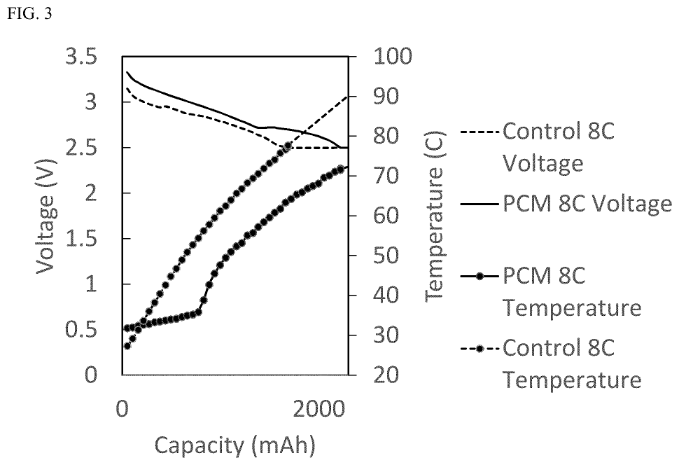

FIG. 3 shows the discharge curves for the control battery and the battery packaged in the Example 1 laminate. FIG. 3 also shows the increasing temperature with discharge for the example and control batteries. In general, the example battery shows a lower temperature than the control battery at any given level of discharge.

This disclosure is further illustrated by the following aspects, which are non-limiting.

Aspect 1: A thermal management battery packaging material comprising a phase-change layer comprising a phase-change composition, wherein the phase-change composition comprises a combination of a phase-change material and a polymer; and a battery packaging layer disposed on a side of the phase-change layer.

Aspect 2: The thermal management battery packaging material of aspect 1, further comprising a protective polymer layer disposed on a side of the phase-change layer opposite the battery packaging layer.

Aspect 3: The thermal management battery packaging material of aspect 1 or 2, wherein the thickness of the phase-change layer is 5 micrometers to 10 millimeter, 10 micrometers to 2 millimeter, or 20 micrometers to 1 millimeter.

Aspect 4: The thermal management battery packaging material of any one or more of aspects 1 to 3, wherein the polymer comprises a polyvinyl chloride, polyether sulfone, acrylonitrile-butadiene-styrene (ABS), styrene-acrylonitrile (SAN), polyvinylidene fluoride (PVDF), silicone rubber, cyclic olefin polymer, fluoropolymer, polyacetal, poly(C₁₋₆ alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polycarbonate, polyester, polyetherimide, polyimide, poly(C₁₋₆ alkyl)methacrylate, polymethacrylamide, polyolefin, polyoxymethylene, polysiloxane, polystyrene, polysulfide, polysulfonamide, polysulfonate, polythioester, polytriazine, polyurea, thermoplastic polyurethane, vinyl polymer, alkyd, bismaleimide polymer, bismaleimide triazine polymer, cyanate ester polymer, benzocyclobutene polymer, diallyl phthalate polymer, epoxy, hydroxymethylfuran polymer, melamine-formaldehyde polymer, phenolic polymer, benzoxazine polymer, polydiene, polyisocyanate, polyurea, thermoset polyurethane, silicone, triallyl cyanurate polymer, triallyl isocyanurate polymer, or a combination thereof; preferably wherein the polymer comprises polyvinyl chloride, polystyrene, polyether sulfone, acrylonitrile-butadiene-styrene (ABS), styrene-acrylonitrile (SAN), polyester, polyethylene naphthalate (PEN), polyethylene terephthalate (PET), polyvinylidene fluoride (PVDF), perfluoromethylvinylether, polypropylene, polyethylene, copolymers of polyethylene or polypropylene, polytetrafluoroethylene, fluorinated ethylene-propylene (FEP), vinylidene fluoride, tetrafluoroethylene-vinylidene fluoride-hexafluoropropylene (HFP), a styrene-ethylene/propylene-styrene block copolymer, a styrene-butadiene block copolymer, a styrene-ethylene/butylene-styrene block copolymer, a polybutadiene, an isoprene, a polybutadiene-isoprene copolymer, an ethylene-propylene rubber, an ethylene-propylene-diene monomer rubber, a natural rubber, a nitrile rubber, butyl rubber, a cyclic olefin copolymer, polydicyclopentadiene rubber, a thermoplastic polyurethane, or a combination thereof.

Aspect 5: The thermal management battery packaging material of any one or more of aspects 1 to 4, wherein the phase-change material comprises a C10-C35 alkane, C10-C35 fatty acid, C10-C55 fatty acid ester, a vegetable oil, or a combination thereof; preferably wherein the phase-change material comprises a C18-28 alkane, C18-28 fatty acid, C18-28 fatty acid ester, or a combination thereof.

Aspect 6: The thermal management battery packaging material of any one or more of aspects 1 to 5, wherein the phase-change material comprises an unencapsulated first phase-change material.

Aspect 7: The thermal management battery packaging material of any one or more of aspects 1 to 5, wherein the phase-change material comprises an encapsulated first phase-change material.

Aspect 8: The thermal management battery packaging material of aspect 7, the phase-change material further comprising an unencapsulated second phase-change material, wherein the first and second phase-change materials can be the same or different, preferably wherein the phase-change material comprises at least 80% encapsulated first phase-change material.

Aspect 9: The thermal management battery packaging material of any one or more of aspects 1 to 8, wherein phase-change composition further comprises an additive composition, wherein the additive composition comprises a flame retardant, a thermal stabilizer, an antioxidant, a thermoconductive filler, a thermally insulating filler, a magnetic filler, a colorant, or a combination thereof.

Aspect 10: The thermal management battery packaging material of any one or more of aspects 1 to 9, wherein the phase-change composition comprises 2 to 40 weight percent, or 4 to 30 weight percent, or 5 to 20 weight percent, or 5 to 15 weight percent of the polymer; 40 to 95 weight percent, or 50 to 90 weight percent, or 60 to 85 weight percent, or 75 to 85 weight percent of the phase-change material; and when present, up to 60 weight percent, 0.1 weight percent to 60 weight percent, or 0.1 to 40 weight percent, or 0.5 to 30 weight percent or 1 to 20 weight percent of an additive composition; wherein each weight percent is based on the total weight of the phase-change composition and totals 100 weight percent.

Aspect 11: The thermal management battery packaging material of any one or more of aspects 1 to 10, wherein the phase-change composition has a transition temperature of 5 to 70° C., preferably 25 to 65° C., more preferably 35 to 60° C., yet more preferably 30 to 50° C.

Aspect 12: The thermal management battery packaging material of any one or more of aspects 1 to 11, wherein the phase-change composition has a heat of fusion, determined by differential scanning calorimetry according to ASTM D3418, at the transition temperature of at least 120 Joules/gram, or at least 150 Joules/gram, preferably at least 180 Joules/gram, more preferably at least 200 Joules/gram.

Aspect 13: The thermal management battery packaging material of any one or more of aspects 1 to 12, wherein the battery packaging layer comprises polyvinyl chloride, polystyrene, polyether sulfone, acrylonitrile-butadiene-styrene, styrene-acrylonitrile polyester, polyethylene naphthalate, polyethylene terephthalate, polyvinylidene fluoride, silicone rubber, polyamide, perfluoromethylvinylether, polyolefin, polypropylene, polyethylene, copolymers of polyethylene or polypropylene, fluorinated polyolefin, polytetrafluoroethylene, fluorinated ethylene-propylene, vinylidene fluoride, tetrafluoroethylene-vinylidene fluoride-hexafluoropropylene, or a combination thereof.

Aspect 14: The thermal management battery packaging material of any one or more of aspects 1 to 13, wherein the battery packaging layer comprises a heat shrink polymer, preferably the heat shrink polymer comprises polyvinyl chloride, polyolefin, polyvinylidene fluoride, silicone rubber, fluorinated polyolefin, polytetrafluoroethylene, fluorinated ethylene-propylene (FEP), or a combination thereof.

Aspect 15: The thermal management battery packaging material of any one or more of aspects 1 to 14, wherein a solubility parameter of the polymer is within ±1, or ±0.9, or ±0.8, or ±0.7, or ±0.6, or ±0.5, or ±0.4, or ±0.3 of the solubility parameter of unencapsulated phase-change material.

Aspect 16: The thermal management battery packaging material of any one of aspects 1 to 15, further comprising a heat-conductive material disposed on a surface of the phase-change layer, preferably wherein the heat-conductive material comprises aluminum, more preferably wherein the heat-conductive material comprises a layer comprising aluminum.

Aspect 17: A method of manufacturing the thermal management battery packaging material of any one or more of aspects 1 to 16, the method comprising contacting the phase-change layer and the battery packaging layer.

Aspect 18: The method of aspect 17, further comprising combining the phase-change material and the polymer and optionally an additive to form a phase-change composition; and forming the phase-change layer from the phase-change composition.

Aspect 19: The method of aspect 17 or 18, wherein the contacting comprises coating the phase-change layer onto the battery packaging layer, coating the battery packaging layer onto the phase-change layer, laminating the phase-change layer and the battery packaging layer, co-extruding the phase-change layer and the battery packaging layer, or adhering the phase-change layer and the battery packaging layer with an adhesive.

Aspect 20: The method of any one of aspects 17 to 19, further comprising contacting a surface of the phase-change layer opposite to the battery packaging layer with a heat-conductive material, preferably wherein the heat-conductive material comprises aluminum, more preferably wherein the heat-conductive material comprises a layer comprising aluminum.

Aspect 21: An article comprising a battery and the thermal management battery packaging material of any one or more of aspects 1 to 16 or made by the method of any one or more of aspects 17 to 20.

Aspect 22: An article comprising a battery component and the thermal management battery packaging material of any one or more of aspects 1 to 16 or made by the method of any one or more of aspects 17 to 20.

Aspect 23: The article of aspect 22, wherein the battery component is a battery cell.

In general, the articles and methods described here can alternatively comprise, consist of, or consist essentially of, any components or steps herein disclosed. The articles and methods can additionally, or alternatively, be manufactured or conducted so as to be devoid, or substantially free, of any ingredients, steps, or components not necessary to the achievement of the function or objectives of the present claims.

The singular forms “a,” “an,” and “the” include plural referents unless the context clearly dictates otherwise. “Or” means “and/or.” Unless defined otherwise, technical and scientific terms used herein have the same meaning as is commonly understood by one of skill in the art to which the claims belong. A “combination” is inclusive of blends, mixtures, solutions, alloys, reaction products, and the like. The values described herein are inclusive of an acceptable error range for the particular value as determined by one of ordinary skill in the art, which will depend in part on how the value is measured or determined, i.e., the limitations of the measurement system. The endpoints of all ranges directed to the same component or property are inclusive of the endpoints and intermediate values, and independently combinable. In a list of alternatively useable species, “a combination thereof” means that the combination can include a combination of at least one element of the list with one or more like elements not named. Also, “at least one of” means that the list is inclusive of each element individually, as well as combinations of two or more elements of the list, and combinations of at least one element of the list with like elements not named.

Unless specified otherwise herein, all test standards are the most recent standard in effect as of the filing date of this application, or, if priority is claimed, the filing date of the earliest priority application in which the test standard appears. Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the disclosed subject matter is described herein in terms of some embodiments and representative examples, those skilled in the art will recognize that various modifications and improvements can be made to the disclosed subject matter without departing from the scope thereof. Additional features known in the art likewise can be incorporated. Moreover, although individual features of some embodiments of the disclosed subject matter can be discussed herein and not in other embodiments, it should be apparent that individual features of some embodiments can be combined with one or more features of another embodiment or features from a plurality of embodiments.

What is claimed is:

1. A thermal management battery packaging material comprising
a phase-change layer comprising a phase-change composition, wherein the phase-change composition comprises a combination of a phase-change material, and a polymer; and
a battery packaging layer disposed on a side of the phase-change layer.

2. The thermal management battery packaging material of claim 1, further comprising
a protective polymer layer disposed on a side of the phase-change layer opposite the battery packaging layer.

3. The thermal management battery packaging material of claim 1, wherein a thickness of the phase-change layer is 5 micrometers to 10 millimeters.

4. The thermal management battery packaging material of claim 1, wherein the polymer comprises a polyvinyl chloride, polyether sulfone, acrylonitrile-butadiene-styrene, styrene-acrylonitrile, polyvinylidene fluoride, silicone rubber, cyclic olefin polymer, fluoropolymer, polyacetal, poly(C₁₋₆ alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polycarbonate, polyester, polyetherimide, polyimide, poly(C₁₋₆ alkyl)methacrylate, polymethacrylamide, polyolefin, polyoxymethylene, polysiloxane, polystyrene, polysulfide, polysulfonamide, polysulfonate, polythioester, polytriazine, polyurea, thermoplastic polyurethane, vinyl polymer, alkyd, bismaleimide polymer, bismaleimide triazine polymer, cyanate ester polymer, benzocyclobutene polymer, diallyl phthalate polymer, epoxy, hydroxymethylfuran polymer, melamine-formaldehyde polymer, phenolic polymer, benzoxazine polymer, polydiene, polyisocyanate, polyurea, thermoset polyurethane, silicone, triallyl cyanurate polymer, triallyl isocyanurate polymer, or a combination thereof.

5. The thermal management battery packaging material of claim 1, wherein the phase-change material comprises a C10-C35 alkane, C10-C35 fatty acid, C10-C55 fatty acid ester, a vegetable oil, or a combination thereof.

6. The thermal management battery packaging material of claim 1, wherein the phase-change material comprises an unencapsulated first phase-change material.

7. The thermal management battery packaging material of claim 1, wherein the phase-change material comprises an encapsulated first phase-change material.

8. The thermal management battery packaging material of claim 7, the phase-change material further comprising an unencapsulated second phase-change material, wherein the first and second phase-change materials can be the same or different, preferably wherein the phase-change material comprises at least 80% encapsulated first phase-change material.

9. The thermal management battery packaging material of claim 1, wherein the phase-change composition further comprises an additive composition, wherein the additive composition comprises a flame retardant, a thermal stabilizer, an antioxidant, a thermoconductive filler, a thermally insulating filler, a magnetic filler, a colorant, or a combination thereof.

10. The thermal management battery packaging material of claim 1, wherein the phase-change composition comprises
2 to 40 weight percent of the polymer;
40 to 97 weight percent of the phase-change material; and
when present, up to 60 weight percent, of an additive composition;
wherein each weight percent is based on the total weight of the phase-change composition and totals 100 weight percent.

11. The thermal management battery packaging material of claim 10, wherein the phase-change composition has a transition temperature of 5 to 70° C.

12. The thermal management battery packaging material of claim 1, wherein the phase-change composition has a heat of fusion, determined by differential scanning calorimetry according to ASTM D3418, at the transition temperature of at least 120 Joules/gram.

13. The thermal management battery packaging material of claim 1, wherein the battery packaging layer comprises polyvinyl chloride, polystyrene, polyether sulfone, acrylonitrile-butadiene-styrene, styrene-acrylonitrile, polyester, polyethylene naphthalate, polyethylene terephthalate, polyvinylidene fluoride, silicone rubber, polyamide, perfluoromethylvinylether, polyolefin, polypropylene, polyethylene, copolymers of polyethylene or polypropylene, fluorinated polyolefin, polytetrafluoroethylene, fluorinated ethylene-propylene, vinylidene fluoride, tetrafluoroethylene-vinylidene fluoride-hexafluoropropylene, or a combination thereof.

14. The thermal management battery packaging material of claim 1, wherein the battery packaging layer comprises a heat shrink polymer.

15. The thermal management battery packaging material of claim 1, wherein a solubility parameter of the polymer is within ±1 of the solubility parameter of the phase-change material.

16. The thermal management battery packaging material of claim 1, further comprising a heat-conductive material disposed on a surface of the phase-change layer.

17. A method of manufacturing the thermal management battery packaging material of claim 1, the method comprising contacting the phase-change layer and the battery packaging layer.

18. The method of claim 17, further comprising
combining the phase-change material and the polymer and optionally an additive to form a phase-change composition; and
forming the phase-change layer from the phase-change composition.

19. The method of claim 17, wherein the contacting comprises coating the phase-change layer onto the battery packaging layer, coating the battery packaging layer onto the phase-change layer, laminating the phase-change layer and the battery packaging layer, co-extruding the phase-change layer and the battery packaging layer, or adhering the phase-change layer and the battery packaging layer with an adhesive.

20. The method of claim 17, further comprising
contacting a surface of the phase-change layer opposite to the battery packaging layer with a heat-conductive material.

21. An article comprising a battery and the thermal management battery packaging material of claim 1.

22. An article comprising a battery component and the thermal management battery packaging material of claim 1.

23. The article of claim 22, wherein the battery component is a battery cell.
